(19) United States
(12) Patent Application Publication
(10) Pub. No.: US 2013/0022090 A1
(43) Pub. Date: Jan. 24, 2013

(54) Dynamic Cyclic Prefix Mode for Uplink Radio Resource Management

(71) Applicants: Jianfeng Weng, Kanata (CA); Yongkang Jia, Kanata (CA); Shiguang Guo, Kanata (CA)

(72) Inventors: Jianfeng Weng, Kanata (CA); Yongkang Jia, Kanata (CA); Shiguang Guo, Kanata (CA)

(21) Appl. No.: 13/554,699

(22) Filed: Jul. 20, 2012

Related U.S. Application Data
(63) Continuation of application No. PCT/CA2011/050445, filed on Jul. 21, 2011.

(51) Int. Cl. H04L 27/28; H04B 1/38

(52) U.S. Cl. 375/219; 375/260

(57) ABSTRACT

Systems and methods can be implemented on a base station and one or more mobile devices to use dynamic cyclic prefix mode for uplink radio resource management. A base station may receive an uplink signal from each of a plurality of mobile devices. The base station can then estimate, based on the received uplink signal, a channel characteristic of the uplink channel for each of the plurality of mobile devices, and determine, based on comparing the estimated channel characteristic to a characteristic threshold, a cyclic prefix mode for each of the plurality of mobile devices.

### CROSS-REFERENCE TO RELATED APPLICATIONS

This application is a continuation of and claims the benefit of PCT Application No. PCT/CA2011/050445, entitled “Dynamic Cyclic Prefix Mode for Uplink Radio Resource Management,” filed on Jul. 21, 2011, the entire contents of which are hereby incorporated by reference.

### TECHNICAL FIELD

This disclosure relates to wireless communications and, more particularly, to uplink radio resource management.

### BACKGROUND

In wireless communications, a radio signal may arrive at the receiver through multiple propagation paths with different delays. This propagation phenomenon is called multipath effect. The multipath effect may be caused by terrestrial objects proximate to the communication path acting as reflectors that reflect the transmit signal. The reflected transmit signal may arrive at the receiver at different time delays from different angles of arrival, causing a multipath delay spread. If the multipath delay spread is non-trivial as compared with the symbol interval of the transmitted signal, the resulting superposition of multiple transmitted symbols may cause inter-symbol interference at the receiver, which makes the received signal hard to decode.

In some wireless systems, orthogonal frequency division multiplexing (OFDM) technique is used as a radio access technology. To combat the possible inter-symbol interference caused by multipath effect in a multipath fading channel, at the transmitter, a cyclic prefix may be prepended to each OFDM symbol as a guard interval. For a given OFDM symbol, the cyclic prefix may be a replica of a few samples at the end of the OFDM symbol. The length, i.e., the time duration, of the cyclic prefix is typically chosen to be longer than the multipath delay spread, such that a circular convolution time portion, from a linear convolution of the cyclic prefix prepended OFDM symbols and the multipath fading channel, can be extracted to allow the use of a simple cyclic prefix removal followed by an efficient Fast Fourier Transformation as part of the demodulation at a receiver. The inter-symbol interference caused by multipath fading can be eliminated after the removal of the cyclic prefix at the receiver. When multiple user devices are served by a cellular base station or broadband base station, uplink signals from those user devices to the base station may be different and their respective uplink channels may have different multipath delay spread. Accordingly, the cyclic prefix for all uplink signals intended to the base station are typically chosen to be the same and be longer than the largest uplink multipath delay spread. Uplink radio resource management is done by the base station scheduling user devices to share the uplink resources in at least one of different time portion and/or different frequency portion. Besides using cyclic prefix for combating inter-symbol interference, in some instances, an equalizer (i.e., a digital filter) may be used to help decoding interference contaminated received signals.

### DESCRIPTION OF DRAWINGS

FIG. 1 is a schematic representation of an example wireless cellular communication system based on 3GPP long term evolution (LTE).

FIG. 2 is a schematic representation of the architecture of an example wireless station.

FIG. 3 is a diagram showing an example scheduling of uplink subframes that includes different cyclic prefix lengths.

FIG. 4 is a block diagram showing an example implementation of channel pre-equalization.

FIG. 5 is a diagram showing an example process of uplink scheduling at a base station.

FIG. 6 is a diagram showing an example process of uplink scheduling at user equipment.

FIG. 7 is a block diagram showing an example implementation of single-input-single-output (SISO) uplink channel pre-equalization.

FIG. 8 is a block diagram showing an example implementation of single-input-multiple-output (SIMO) uplink channel pre-equalization.

FIG. 9 is a block diagram showing an example implementation of multiple-input-multiple-output (MIMO) uplink channel pre-equalization.

Like reference symbols in the various drawings indicate like elements.

### DETAILED DESCRIPTION

The present disclosure provides for systems, methods, and apparatuses relating to wireless communications and, more particularly, to uplink radio resource management. In a wireless cellular network or a wireless broadband network that uses orthogonal frequency division multiplexing (OFDM) as radio access technology (e.g. 3GPP long term evolution, IEEE 802.16m), a cyclic prefix may be prepended to each OFDM symbol to circumvent inter-symbol interference caused by multipath delay spread. The cyclic prefix can have different lengths, and cyclic prefixes with different lengths may correspond to different cyclic prefix modes. In some aspects, a base station identifies a multipath delay spread for each of the uplink channels associated with multiple mobile electronic devices. Based on comparing the identified multipath delay spread with one or more pre-determined multipath delay spread threshold, the base station may determine a cyclic prefix mode for each of the multiple mobile electronic devices to transmit at a certain time interval. The determined cyclic prefix mode may have among all possible cyclic prefix modes the shortest possible cyclic prefix length that is longer than the multipath delay spread. A shorter cyclic prefix length may result in less overhead in utilizing uplink radio resources and a higher spectrum efficiency. In some implementations, at least a portion of mobile electronic devices with the same determined cyclic prefix mode are scheduled to transmit at the same time interval using same cyclic prefix length according to the cyclic prefix mode.

In some aspects, an equalizer may be used by a mobile electronic device to perform a time domain channel pre-equalization in order to reduce the length of the multipath delay spread. The filter coefficients of the equalizer may be determined by the base station based on uplink channel estimation. The determined equalization coefficients may be communicated back to the mobile electronic device to configure the time-domain pre-equalizer. The base station may also estimate an updated multipath delay spread assuming the mobile electronic device has applied the previously communicated filter coefficients for the time domain channel pre-equalization. Accordingly, the base station may determine an updated cyclic prefix mode for the mobile electronic device based on the estimated updated multipath delay spread and indicate the uplink signal of the mobile electronic device to be transmitted at a time interval according to the updated cyclic prefix length.

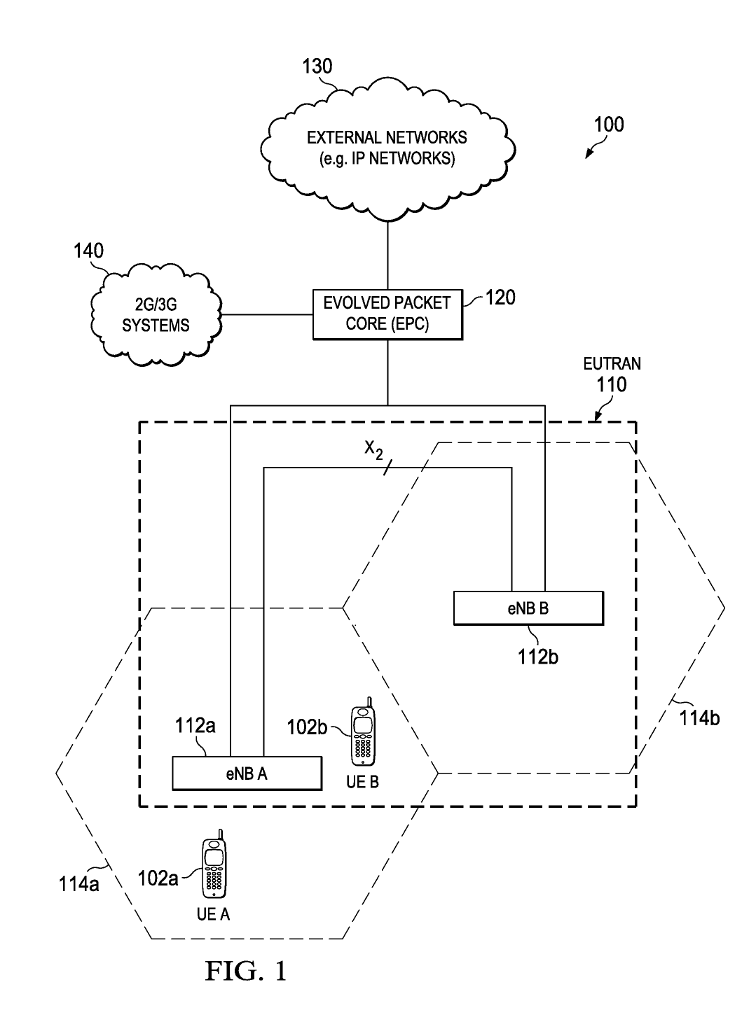

The mobile electronic devices described above may operate in a cellular network, such as the network shown in FIG. 1, which is based on the third generation partnership project (3GPP) long term evolution (LTE), also known as Evolved Universal Terrestrial Radio Access (E-UTRA). More specifically, FIG. 1 is a schematic representation of an example wireless cellular communication system 100 based on 3GPP long term evolution. The cellular network system 100 shown in FIG. 1 includes a plurality of base stations 112. In the LTE example of FIG. 1, the base stations are shown as evolved Node B (eNB) 112. It will be understood that the base station may operate in any mobile environment including femto cell, pico cell, or the base station may operate as a node that can relay signals for other mobile and/or base stations. The example LTE telecommunications environment 100 of FIG. 1 may include one or a plurality of radio access networks 110, core networks (CNs) 120, and external networks 130. In certain implementations, the radio access networks may be Evolved Universal Mobile Telecommunications System (UMTS) terrestrial radio access networks (EUTRANs). In addition, in certain instances, core networks 120 may be evolved packet cores (EPCs). Further, there may be one or more mobile electronic devices 102 operating within the LTE system 100. In some implementations, 2G/3G systems 140, e.g., Global System for Mobile communication (GSM), Interim Standard 95 (IS-95), Universal Mobile Telecommunications System (UMTS) and CDMA2000 (Code Division Multiple Access) may also be integrated into the LTE telecommunication system 100.

In the example LTE system shown in FIG. 1, the EUTRAN 110 comprises eNB 112a and eNB 112b. Cell 114a is the service area of eNB 112a and Cell 114b is the service area of eNB 112b. UE 102a and 102b operate in Cell 114a and are served by eNB 112a. The EUTRAN 110 can comprise one or a plurality of eNBs 112 and one or a plurality of UEs can operate in a cell. The eNBs 112 communicate directly to the UEs 102. In some implementations, the eNB 112 may be in a one-to-many relationship with the UE 102, e.g., eNB 112a in the example LTE system 100 can serve multiple UEs 102 (i.e., UE 102a and UE 102b) within its coverage area Cell 114a, but each of UE 102a and UE 102b may be connected only to one eNB 112a at a time. In some implementations, the eNB 112 may be in a many-to-many relationship with the UEs 102, e.g., UE 102a and UE 102b can be connected to eNB 112a and eNB 112b. The eNB 112a may be connected to eNB 112b with which handover may be conducted if one or both of UE 102a and UE 102b travels from eNB 112a to eNB 112b. UE 102 may be any wireless electronic device used by an end-user to communicate, for example, within the LTE system 100. The UE 102 may be referred to as mobile electronic device, user device, mobile station, subscriber station, or wireless terminal UE 102 may be a cellular phone, personal data assistant (PDA), smart phone, laptop, tablet personal computer (PC), pager, portable computer, or other wireless communications device.

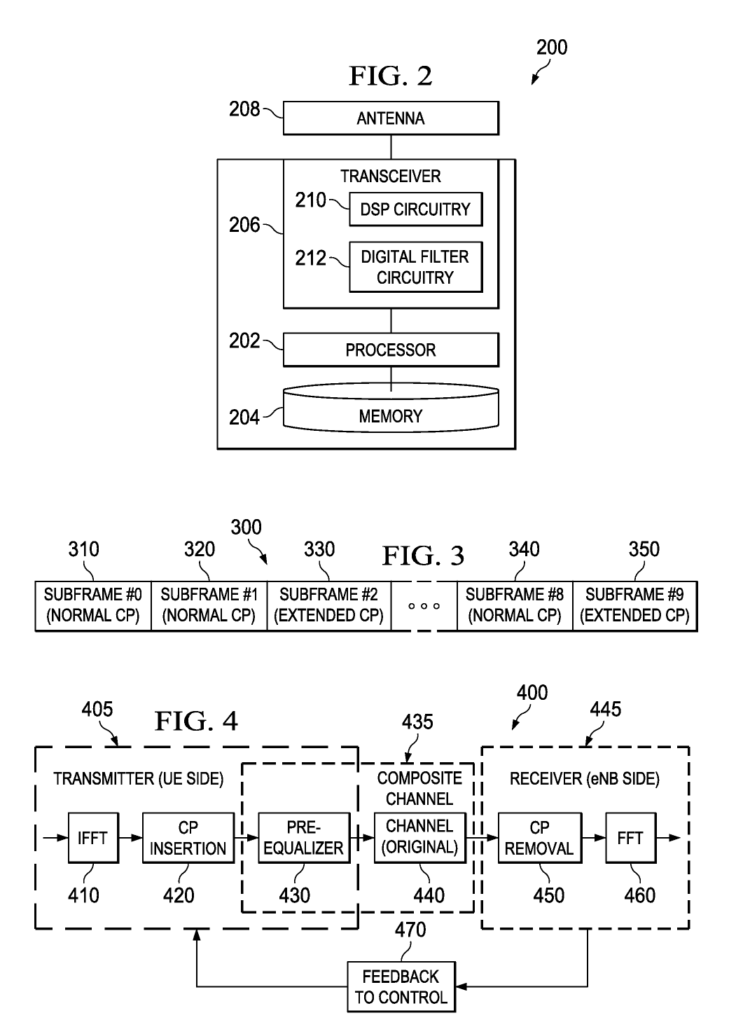

Turning briefly to FIG. 2, each wireless station may be any electronic device operable to transmit and receive wireless signals in the LTE telecommunication system 100. In the present disclosure, a wireless station can be either a mobile electronic device (e.g., UE) or a base station (e.g., an eNB). FIG. 2 is a schematic illustration of an example wireless station 200. A wireless station 200 may include a processor 202, a memory 204, a wireless transceiver 206, and an antenna 208. The processor 202 may comprise a microprocessor, central processing unit, graphic control unit, network processor, or other processor for carrying out instructions stored in memory 204. The functions of the processor 202 may include computation, queue management, control processing, graphic acceleration, video decoding, and execution of a sequence of stored instructions from the program kept in the memory module 204. In some implementations, the processor 202 may also be responsible for signal processing including sampling, quantizing, encoding/decoding, and/or modulation/demodulation of the signal. The memory module 204 may include a temporary state device (e.g., random-access memory (RAM)) and data storage. The memory module 204 can be used to store data or programs (i.e., sequences of instructions) on a temporary or permanent basis for use in a UE.

The wireless transceiver 206 can include both the transmitter circuitry and the receiver circuitry. The wireless transceiver 206 may be responsible for converting a baseband signal to a passband signal or vice versa. The components of wireless transceiver 206 may include a digital to analog converter/analog to digital converter, amplifier, frequency filter and oscillator. In addition, the wireless transceiver 206 may also include or be communicably coupled to a digital signal processing (DSP) circuitry 210 and a digital filter circuitry 212. The DSP circuitry 210 may perform functionalities includes generating OFDM and/or single carrier-frequency division multiple access (SC-FDMA) signals. OFDM is a frequency division multiplexing technology used as a multiple subcarrier modulation method. OFDM signal can be generated by modulating an information bearing signal, e.g., a sequence of bit-mapped symbols, on multiple orthogonal subcarriers. Different bit-mapped symbols modulated on different subcarriers may each be considered to experience a flat fading channel, i.e., the frequency response of a fading channel for each subcarrier can be considered flat, such that the information may be easier to decode at the receiver. In some practical implementations, OFDM uses fast Fourier transform (FFT) and inverse fast Fourier transform (IFFT) to alternate between time and frequency domain representations of the signal. The FFT operation can convert the signal from a time domain representation to a frequency domain representation. The IFFT operation can do the conversion in the opposite direction. While OFDM may be used in the radio downlink, SC-FDMA technology may be used in the radio uplink. SC-FDMA uses substantially similar modulation scheme as OFDM to modulate uplink signal to multiple subcarriers. Among other differences with OFDM, a multi-point Discrete Fourier Transform (DFT) operation is performed before subcarrier mapping and IFFT in SC-FDMA on the transmitter side in order to reduce peak-to-average power ratio of the modulated signal. Since uplink signals are transmitted from UEs, a lower peak-to-average power ratio of the modulated signal may result in a lower cost signal amplification at UEs.

The digital filter circuitry 212 may include an equalization filter that is used for signal equalization. Equalization can be the process of adjusting the balance between frequency components within a radio signal. More specifically, equalizers may be used to render the frequency response flat from the transmitter to the equalized output and within the entire channel bandwidth of interest. When a channel has been equalized, the frequency domain attributes of the signal at the equalized output may be substantially similar to those of the transmitted signal at the transmitter. Equalizer may include one or more filter taps, each tap may correspond to a filter coefficient. The filter coefficients may be adjusted according to the variation of channel/system condition.

The antenna 208 is a transducer which can transmit and/or receive electromagnetic waves. Antenna 208 can convert electromagnetic radiation into electric current, or vice versa. Antenna 208 is generally responsible for the transmission and reception of radio waves, and can serve as an interface between the transceiver 206 and the wireless channel. In some implementations, the wireless station 200 may be equipped with more than one antenna to take advantage of multiple-input-multiple-output (MIMO) technology. MIMO technology may provide a process to utilize multiple signal paths to reduce the impact of multipath fading and/or to improve the throughput. By using multiple antennas at a wireless station, MIMO technology may enable a transmission of multiple parallel data streams on the same wireless channel, thereby increasing the throughput of the channel.

Returning to the illustration of FIG. 1, UEs 102 may transmit voice, video, multimedia, text, web content and/or any other user/client-specific content. On the one hand, the transmission of some of these contents, e.g., video and web content, may require high channel throughput to satisfy the end-user demand. On the other hand, the channel between UEs 102 and eNBs 112 may be contaminated by multipath fading, due to the multiple signal paths arising from many reflections in the wireless environment. Accordingly, the UEs' transmission may adapt to the wireless environment. In short, UEs 102 generate requests, send responses or otherwise communicate in different means with Enhanced Packet Core (EPC) 120 and/or Internet Protocol (IP) networks 130 through one or more eNBs 112.

A radio access network is part of a mobile telecommunication system which implements a radio access technology, such as UMTS, CDMA2000 and 3GPP LTE. In many applications, the Radio Access Network (RAN) included in a LTE telecommunications system 100 is called an EUTRAN 110. The EUTRAN 110 can be located between UEs 102 and EPC 120. The EUTRAN 110 includes at least one eNB 112. The eNB can be a radio base station that may control all or at least some radio related functions in a fixed part of the system. The at least one eNB 112 can provide radio interface within their coverage area or a cell for UEs 102 to communicate. eNBs 112 may be distributed throughout the cellular network to provide a wide area of coverage. The eNB 112 directly communicates to one or a plurality of UEs 102, other eNBs, and the EPC 120.

The eNB 112 may be the end point of the radio protocols towards the UE 102 and may relay signals between the radio connection and the connectivity towards the EPC 120. In certain implementations, the EPC 120 is the main component of a core network (CN). The CN can be a backbone network, which may be a central part of the telecommunications system. The EPC 120 can include a mobility management entity (MME), a serving gateway (SGW), and a packet data network gateway (PGW). The MME may be the main control element in the EPC 120 responsible for the functionalities comprising the control plane functions related to subscriber and session management. The SGW can serve as a local mobility anchor, such that the packets are routed through this point for intra EUTRAN 110 mobility and mobility with other legacy 2G/3G systems 140. The SGW functions may include the user plane tunnel management and switching. The PGW may provide connectivity to the services domain comprising external networks 130, such as the IP networks. The UE 102, EUTRAN 110, and EPC 120 are sometimes referred to as the evolved packet system (EPS). It is to be understood that the architectural evolvement of the LTE system 100 is focused on the EPS. The functional evolution may include both EPS and external networks 130.

Though described in terms of FIG. 1, the present disclosure is not limited to such an environment. In general, cellular telecommunication systems may be described as cellular networks made up of a number of radio cells, or cells that are each served by a base station or other fixed transceiver. The cells are used to cover different areas in order to provide radio coverage over an area. Example cellular telecommunication systems include Global System for Mobile Communication (GSM) protocols, Universal Mobile Telecommunications System (UMTS), 3GPP Long Term Evolution (LTE), and others. In addition to cellular telecommunication systems, wireless broadband communication systems may also be suitable for the various implementations described in the present disclosure. Example wireless broadband communication system includes IEEE 802.11 wireless local area network, IEEE 802.16 WiMAX network, etc.

FIG. 3 is a diagram 300 showing an example scheduling of uplink subframes that includes different cyclic prefix lengths. In some wireless systems, uplink and downlink transmission are organized into time frames. Each frame may further include multiple subframes. In LTE system, frames may be used to manage the transmission of system information blocks so UEs may know when to expect system-related information. The length of the frame in LTE is 10 ms, and each frame contains 10 subframes, with each subframe 1 ms long. System resources may be allocated to UEs on a subframe basis, allowing radio resources to be reassigned every millisecond. Each subframe may contain 2 slots, each 0.5 ms long. A single slot may contain 6 extended CP OFDM/SC-FDMA symbols or 7 normal CP OFDM/SC-FDMA symbols for 15 kHz subcarrier spacing configuration. A shorter CP length may result in less overhead and higher spectrum efficiency. For example, 7 normal CP OFDM/SC-FDMA symbols per time slot in a normal CP configuration can provide one more OFDM/SC-FDMA symbol per time slot as uplink radio resources to carry data than 6 extended CP OFDM/SC-FDMA symbols per time slot in an extended CP configuration.

In general, uplink signals from multiple UEs intended to a base station, i.e., an eNB, may experience different propagation delays and their respective uplink channels may have different multipath delay spread, which may result in uplink signals from different UEs interfering with each other. In order to reduce the amount of interference in the uplink between different UEs, in some instances, the eNB may control each UE's uplink timing via a time-advanced transmission to overcome the corresponding propagation delay, so that the uplink subframes from all UEs can arrive at the eNB in a synchronized fashion. In some instances, the eNB may choose proper CP configuration for all UEs in the cell as a guard time interval to circumvent the multipath delay spread.

Returning to the illustrated example 300, a base station may configure uplink time subframes dynamically as either normal CP subframe or extended CP subframe. For each subframe, the CP mode used in the uplink may be different from the CP mode used in the downlink. The base station may then schedule UEs that can use normal CP to transmit using radio resources of normal CP subframes (such as subframe #0, 310, subframe #1 320, and subframe #8 340), and schedule UEs that use extended CP to transmit using radio resources of extended CP subframes (such as subframe #2 330 and subframe #9 350). In some instances, the radio resources in the uplink subframes configured as normal CP mode may be used up, the base station may instead schedule the UEs that can use normal CP to transmit with extended CP during extended CP subframes so as to share those extended CP uplink subframes with the UEs that have to use extended CP. In the particular example shown in FIG. 3, the uplink subframes are configured to accommodate signals with two different CP modes, i.e., the normal CP mode and the extended CP mode. In some other instances, there may be more than two different CP modes, and more than two types of subframes may be configured accordingly to adapt to uplink signals with more than two possible CP modes. In general, by arranging subframes to support uplink signals with different CP lengths, a base station can serve UEs with different CP modes and can dynamically change a UE's uplink CP mode when its uplink channel condition is changed so that for a group of UEs with uplink channels having multipath delay spread shorter than the normal CP length, the base station can configure the system and schedule for the group of UEs to use the normal CP mode, which can provide higher spectrum efficiency than the extended CP mode.

FIG. 4 is a block diagram 400 showing an example implementation of channel pre-equalization. At a high level, the channel pre-equalization is performed in the time domain at the transmitter side of a UE, in order to shorten the multipath delay spread of an uplink channel. That would potentially allow the UE to use a shorter CP length. When the multipath delay spread is shortened, a CP mode associated with a shorter CP may be used by the UE to generate uplink signals to achieve a higher spectrum efficiency. In the illustrated example implementation 400, at the transmitter side (UE side) 405, frequency domain input signal is fed into an IFFT block 410. The IFFT block 410 is used to convert a frequency domain signal into a time-domain transmit signal. The time domain signal from one IFFT conversion is corresponding to one OFDM/SC-FDMA symbol transmission, henceforth to be referred to as one OFDM symbol. CP insertion is performed at block 420. A CP can be inserted by copying a certain number of samples from the end of each OFDM symbol and prepending these copied samples to the beginning of the OFDM symbol. At 430, a time-domain pre-equalizer is used for shortening the multipath delay spread of a composite channel 435, i.e., an overall channel (the linear convolution of pre-equalizer 430 and the original wireless channel 440) experienced by the output signal from the CP insertion block 420. The composite effect of the pre-equalization performed at pre-equalizer 430 and the original channel 440 on the CP inserted output signal may be considered for the decoding at the receiver side 445.

In general, the use of the CP insertion 420 is to create a circular convolution time portion from a linear convolution of the CP inserted output and the composite channel so that at the receiver side 445 a simple CP removal block 450 followed by an FFT block 460 can be used in demodulating the transmitted OFDM symbol. In some implementations, in the absence of a time-domain pre-equalizer 430, the length of the CP used may be larger than the multipath delay spread of the original channel 440 in order to secure a circular convolution time portion from the linear convolution between the CP inserted output and the original channel. With a time-domain pre-equalizer 430 to shorten the multipath delay spread of the composite channel 435, a shorter CP length can be used even though the original channel might have a large multipath delay spread, which would otherwise require a longer CP length.

Returning to the illustrated example 400, the “pre-equalizer” 430 described in this example 400 can be any kind of digital filter for channel equalization. For example, the pre-equalizer can be a feed-forward equalizer, a feedback equalizer, a feed-back equalizer followed by a feed-forward equalizer, i.e., a Tomlinson-Harashima Precoding (THP) unit followed by a feed-forward equalizer (FFE). The transfer functions of THP and FFE by using a z-transform can be written as, respectively,

$$\begin{matrix}{H}_{THP} ( z ) = \frac{1}{1 + {\sum }_{m = 1}^{{L}_{1}} {b}_{m} {z}^{- m}} \\ and & ( 1 ) \\ {H}_{FFE} ( z ) = {\sum }_{m = 0}^{{L}_{2} - 1} {c}_{m} {z}^{- m} & ( 2 )\end{matrix}$$

where {bₘ, m=1, 2, . . . , L₁} is a set of filter coefficients in the time-domain THP with order L₁, {cₘ, m=0, 1, . . . , L₂−1} is a set of filter coefficients for the time-domain feed-forward equalizer with order L₂.

In some implementations, at least one of the THP and FFE is bypassed or configured as a whole-pass filter. Setting {bₘ} to 0 or setting L₁ to 0 can effectively bypass the THP (The THP becomes a whole-pass filter). Setting c₀ to 1 and all other {cₘ} to 0 can effectively bypass the FFE (The FFE becomes a whole-pass filter). In some implementations, an amplitude clipper is added to the THP to limit the amplitude of the THP output samples so as to make sure the stability of the THP.

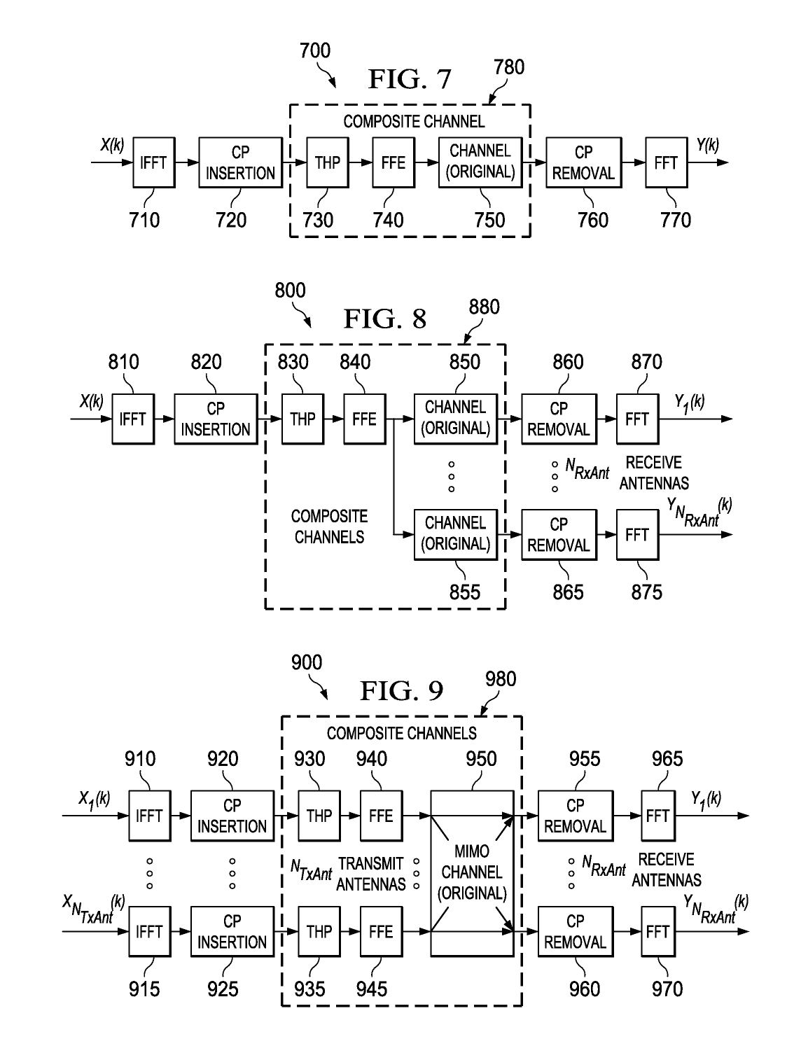

At the receiver side (eNB side) 445, the CP is removed 450, so that inter-symbol interference caused by multipath spread that falls into the CP portion of the signal can be eliminated. The time-domain signal is then converted back to the frequency domain using an FFT at 460. In some implementations, the receiver 445 may also perform channel estimation, pre-equalizer coefficient determination, and CP mode determination (not shown). Furthermore, the receiver 445 may decide, if feedback information is needed to be sent back to the transmitter 405 of a UE, to adjust the pre-equalizer coefficients and/or if the CP mode of the UE needs to be updated. The feedback information may be sent back to the transmitter 405 at 470 via a downlink channel, signal, or message. A few channel pre-equalization implementations suitable for the present disclosure are further described in the illustrations of FIG. 7, FIG. 8 and FIG. 9.

In some implementations, channel pre-equalization may be used together with the dynamic uplink CP mode configuration described in the illustration of FIG. 3. As such, the eNB may enable more UEs to use, as a means of uplink radio resource management, the normal CP mode for their uplink transmissions in order to increase uplink channel capacity.

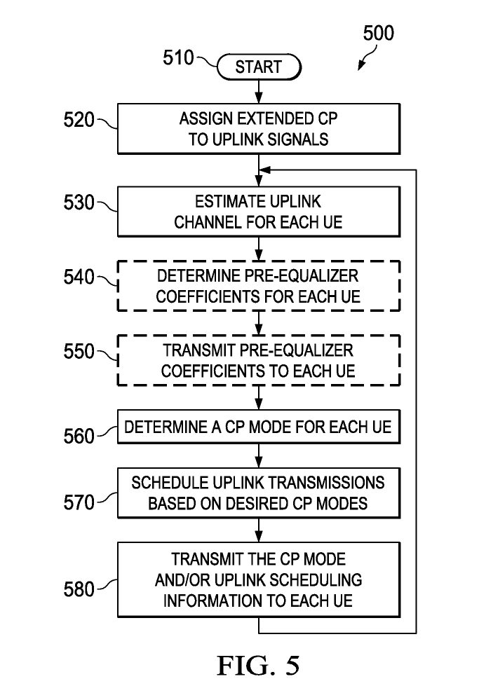

FIG. 5 is a diagram 500 showing an example process of uplink scheduling at a base station. The base station may be an eNB 112 as described in the illustration of FIG. 1. The process starts at 510. At 520, the eNB performs a CP mode initialization by assigning an extended CP mode to each of the UEs served by the eNB. Based on deployment scenarios, the eNB can assume a large uplink channel multipath delay spread for at least one uplink channel, and assign uplink transmission using extended CP mode for each of the UEs served by the eNB. In some implementations, the eNB decides to assign an extended CP mode for each UE based on determining a worst case multipath delay spread is greater than the length of the normal CP. The worst case multipath delay spread for a cell may be determined by first estimating multipath delay spread values at different locations throughout the cell and then selecting the largest one from those estimated values. The worst case delay spread may be compared with the length of the normal CP to determine if the normal CP could be used. In some instances, the estimation operation can happen during a cell deployment phase.

At 530, the eNB performs an uplink channel estimation for each of the UEs. The operation of channel estimation may include the estimation of channel impulse response and the estimation of a characteristic of the uplink channel. The characteristic may be any characteristic representative of at least one aspect of the uplink channel. Example channel characteristic may include multipath delay spread, coherence time, path loss, signal to noise ratio and residual inter-symbol interference. In this particular implementation 500, multipath delay spread may be considered as the uplink channel characteristic estimated by the eNB during channel estimation. At 540, the eNB may determine pre-equalizer coefficients for each UE that can be used by the UE to perform uplink channel pre-equalization. The pre-equalizer coefficients may be determined based on the uplink channel estimation. In some implementations, a UE does not have an equalizer to perform any channel pre-equalization, and can use only a dynamic uplink CP mode according to the eNB's assignment. In some implementations, the eNB may decide not to apply any pre-equalization for the UEs that may transmit at their maximum transmit power level. Those UEs could be cell-edge UEs or UEs reporting smaller transmit power head-rooms. Yet in some other implementations, the eNB may choose not to use any pre-equalization at UEs. In those cases, the operation 540 for one or more identified UEs may not be performed by the eNB. At 550, the eNB may transmit pre-equalizer coefficients to UEs. In some implementations, pre-equalizer coefficients for each UE may be transmitted using Downlink Control Information (DCI) messages in Physical Downlink Control CHannel (PDCCH) or radio resource control (RRC) messages. In some instances, the eNB transmits the entire determined pre-equalizer coefficients to each UE. In some other instances, the eNB transmits only the difference of the current pre-equalizer coefficients compared to the previous pre-equalizer coefficients to a UE, such that the UE may update its pre-equalizer coefficients. The eNB may not transmit any pre-equalizer coefficients to a UE when it has determined that the pre-equalizer coefficients at the UE may not need any update or the UE does not need any channel pre-equalization. A few example implementations of uplink channel estimation and pre-equalizer coefficients determination at the eNB for various input and output scenarios are further described in the illustrations of FIG. 7, FIG. 8 and FIG. 9.

At 560, the eNB determines the desired CP mode for each UE. The desired CP mode for a UE may be determined based on comparing the estimated multipath delay spread of the uplink channel from the UE with the normal CP duration. If the estimated channel multipath delay spread of a UE is less than the normal CP duration, the desired CP mode for the UE can be set to “Normal”. Otherwise, it can be set to “Extended”. In some implementations, an eNB can estimate the uplink channel of a UE based on an uplink sounding reference signal (SRS) or an uplink demodulation reference signal (DMRS) from the UE. In the estimation, the eNB takes into consideration of the pre-equalizer coefficients being used by the UE. The multipath delay spread may be estimated by calculating the auto-correlation of one or more estimates of the composite channel impulse response, converting the calculated auto-correlation to a frequency domain to obtain a delay power spectrum φ_{c}(τ), and finding a delay value, denoted by Tₘ, beyond which the normalized delay power is less than a pre-configured power threshold, i.e., φ_{c}(Tₘ)/φ_{c}(0)<\tilde{φ}_{T}, where \tilde{φ}_{T} is a pre-configured power threshold. When there is more than one uplink channel from a UE due to the use of multiple transmit antennas at the UE, or the use of multiple receive antennas at the eNB, or both, the multipath delay spread may be estimated for each uplink channel and a maximum Tₘ for the more than one uplink channel may be identified. The maximum Tₘ can be compared with one or more multipath delay spread thresholds to determine the CP mode. For each CP mode, the multipath delay spread threshold may be set equal to the CP duration of the CP mode. If Tₘ<the multipath delay spread threshold corresponding to the Normal CP duration, the desired CP mode for the UE can be assigned as normal CP mode. Otherwise, the desired CP mode can be assigned as extended CP. The desired uplink CP mode may be UE specific, i.e., a desired uplink CP mode may be determined for each UE served by the eNB. Furthermore, for each UE, the assigned desired CP mode may change as the UE moves from one location to another within the service area of the eNB or as the multipath causing reflectors surrounding the UE change. In other words, each UE can have a dynamic uplink CP mode.

At 570, the eNB schedules uplink transmissions for each UE based on the determined desired CP mode of the particular UE. The eNB can group a set of UEs whose desired CP mode is “Normal” to share the same uplink subframe configured in the normal CP mode, and group a set of UEs whose desired CP mode is “Extended” to share the same uplink subframe configured in the extended CP mode. In some implementations, UEs with desired CP mode of “Normal” may be scheduled to transmit in the subframes configured in the extended CP mode by padding the CP to match the extended CP length. However, the UEs with desired CP mode of “Extended” may only share the same uplink subframe configured in the extended CP mode.

At 580, the eNB transmits the determined desired CP mode and/or uplink scheduling information. Once an eNB determines the desired uplink CP mode for a UE and schedules an uplink transmission for the UE, the eNB can send information including an uplink grant message identifying uplink radio resources, and an uplink CP mode to be used by the UE to transmit uplink signals. In some implementations, the transmission of uplink CP mode to the UE can have at least one of the following example options: (1) Embedding a UE-specific uplink CP mode bit (e.g., 0 for normal CP and 1 for extended CP) in the uplink grant message, the uplink CP mode bit for a UE may be associated with an uplink grant message to the UE. The eNB can change the uplink CP mode according to the estimated uplink channel characteristic. In some instances, a new DCI format may be used to support the UE specific CP mode bit; (2) In some transmission periods, an eNB may not transmit any uplink grant message and/or CP mode bit to UE. When the UE does not detect an uplink resource grant and/or CP mode bit in a current transmission, it may assume that its current uplink resource and/or CP mode information may not be updated. Accordingly, the UE may transmit uplink traffic using the uplink grant and/or CP mode used in the previous transmission. On the other hand, the eNB can track the CP modes used by each UE for uplink transmission and make sure the UEs that share the same subframe are using the same CP mode; (3) Predefined normal CP mode or extended CP mode associated with a particular uplink subframe in N radio frames, where N is an integer. This CP mode configuration can be changed semi-statically through a broadcasting message. For example, a common uplink CP mode bit in each downlink subframe, e.g., subframe n, can indicate the CP mode to be used in the uplink subframe n+4, since UEs sharing the same uplink subframe are using the same CP mode, and for any UE, an uplink grant received at downlink subframe n is for the radio resource at uplink subframe n+4. Accordingly, a message identifying the predefined normal CP mode or extended CP mode associate with a particular downlink subframe may be broadcasted in N radio frames; and (4) UE specific RRC message. In some implementations, the CP mode for a UE may not change rapidly. As a result, it may be possible for an eNB to toggle the desired uplink CP mode bit to the UE via a UE specific RRC message.

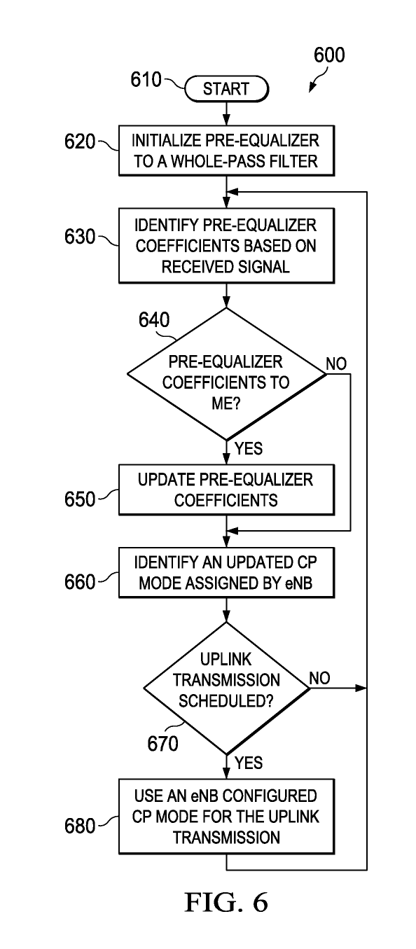

FIG. 6 is a diagram showing an example process 600 related to the uplink pre-equalization at a UE. The process starts at 610. At 620, for a UE that supports channel pre-equalization, it initializes the pre-equalizer coefficients of the equalizer to values that corresponds to a whole pass filter. At 630, the UE identifies pre-equalizer coefficients based on downlink signals received from its serving eNB. In some instances, when an eNB wants to disable channel pre-equalization at a UE, it may either send a set of coefficients to the UE to configure the pre-equalizer to a whole-pass filter or it may never send any information to update the UE pre-equalizer coefficients. At 640, the UE identifies whether a set of pre-equalizer coefficients in the received signal is intended to itself. If yes, at 650, the UE may update its pre-equalizer coefficients according to the identified pre-equalizer coefficients. Otherwise, the UE identifies a CP mode assigned by the eNB based on the received signal at 660. At 670, the UE identifies whether an uplink transmission is scheduled for itself. If yes, the UE transmits its uplink signal using the identified CP mode according to the identified uplink transmission schedule at 680. Otherwise, the UE may continue to monitor downlink signal for signaling information.

FIG. 7 is a block diagram showing an example implementation 700 of single-input-single-output (SISO) uplink channel pre-equalization between a UE and an eNB. For SISO, a single transmit antenna may be used by the UE and a single receive antenna by the eNB. In the illustrated example implementation 700, the input signal fed to the system at the UE side may be denoted as X(k), the output signal at the eNB side may be denoted as Y(k). The IFFT block 710, CP insertion block 720, original wireless channel block 750, CP removal block 760 and FFT block 770 perform substantially similar functionalities as respectively, the IFFT block 410, CP insertion block 420, original wireless channel block 440, CP removal block 450 and FFT block 460 as described in the illustration of FIG. 4. The channel pre-equalization performed by the pre-equalizer in this example 700 may be based on at least one of a Tomlinson-Harashima Precoder (THP) 730 and a Feed Forward Equalizer (FFE) 740.

The channel impulse response estimation and pre-equalizer coefficients determination for the SISO example in FIG. 7 is described in the following illustration. The structure of the pre-equalizer may a combination of a time-domain THP 730 with L₁ taps followed by a FFE 740 with L₂ taps. Their transfer functions can be found in Equation (1) and (2). As described in the illustration of FIG. 5, for each UE, the uplink channel estimation at an eNB may include the estimation of a channel impulse response for data demodulation and the determination of pre-equalizer coefficients for channel pre-equalization.

For channel impulse response estimation, by using the illustrated implementation 700 in FIG. 7, the channel observed at the eNB may be a composite channel 780 that has the composite effect of the pre-equalizer (THP 730 and FFE 740) and the original wireless channel 750 on the uplink signal. By assuming the THP has a short length and its impulse response has a fast decay and the multipath delay spread of the composite channel is less than the CP duration of the CP mode being used, the received frequency domain sample for subcarrier k can be written as

Y(k)=H_{org}(k)·H_{FFE}(k)·H_{THP}(k)·X(k)+N(k) (3)

where H_{org}(k), H_{THP}(k), and H_{FFE}(k) are the frequency responses at subcarrier k of the original channel 750, THP 730, and FFE 740, respectively, X(k) is the input frequency-domain data sample, and N(k) is the frequency domain background white noise sample.

In this example, the uplink demodulation reference signal (DMRS) may be used for the uplink channel estimation at an eNB. Other reference signals may also be used for channel estimation without departing from the scope of the present disclosure. Since X (k) is a reference signal, the eNB may know this parameter. In addition, the eNB can compute the pre-equalizer frequency response used in the THP and FFE, i.e., H_{THP}(k) and H_{FFE}(k), based on the fact that the eNB knows the filter coefficients being used in the pre-equalizer. The THP frequency response, H_{THP}(k) can be expressed as,

$${H}_{THP} ( k ) = {[ 1 + {\sum }_{m = 1}^{{L}_{1}} {b}_{m} {e}^{- j 2 π km / N} ]}^{- 1} \qquad ( 4 )$$

where {bₘ, m=1, 2, . . . , L₁} is a set of filter coefficients being used in the time-domain THP and N is the FFT/IFFT size.

H_{FFE}(k) can be computed based on calculating the FFT of the FFE filter coefficients, i.e.,

$${H}_{FFE} ( k ) = {\sum }_{c = 0}^{{L}_{2} - 1} {c}_{m} {e}^{- j 2 π km / N} \qquad ( 5 )$$

where {cₘ, m=0, 1, . . . , L₂−1} is a set of filter coefficients being used for the FFE.

Therefore, the frequency response of the original channel H_{org}(k) can be estimated, from which the channel impulse response estimate can be derived. In some implementations, some forms of averaging may be performed on one or more channel impulse response estimates from multiple observations to reduce the estimation error.

For the pre-equalizer coefficient determination at the eNB, the goal is to identify a set of THP coefficients {\hat{b}ₘ, m=1, 2, . . . , L₁} and a set of FFE coefficients {ĉₘ, m=0, 1, . . . , L₂−1} such that the impulse response of a composite channel, i.e.,

$${\hat{h}}_{comp} ( n ) = {\tilde{h}}_{org} ( n ) * {\hat{h}}_{FFE} ( n ) - {\sum }_{m = 1}^{{L}_{1}} {\hat{b}}_{m} {\hat{h}}_{comp} ( n - m ) \qquad ( 6 )$$

will have a shorter multipath delay spread. Here, * denotes a linear convolution, \tilde{h}_{org}(n) is the estimated impulse response of the original channel and ĥ_{FFE}(n) is the impulse response of the FFE. The FFE and THP coefficients with a “̂” sign are the coefficients to be determined by the eNB and they have not been communicated to the UE yet.

By assuming that the THP has a low-order and its impulse response has a fast decay, the estimated composite channel impulse response, \tilde{h}_{comp}(n), can be also written as

\tilde{h}_{comp}(n)=IFFT{\tilde{H}_{org}(k)·Ĥ_{FFE}(k)·Ĥ_{THP}(k)} (7)

Equation (7) may be used to approximate ĥ_{comp}(n) in Equation (6). In Equation (7), IFFT represents the IFFT operation and \tilde{H}_{org} (k) is the frequency-domain estimate of the original channel for subcarrier k, and

$$\begin{matrix}{\hat{H}}_{THP} ( k ) = {[ 1 + {\sum }_{m = 1}^{{L}_{1}} {\hat{b}}_{m} {e}^{- j 2 π km / N} ]}^{- 1} & ( 8 ) \\ {\hat{H}}_{FFE} ( k ) = {\sum }_{c = 0}^{{L}_{2} - 1} {\hat{c}}_{m} {e}^{- j 2 π km / N} & ( 9 )\end{matrix}$$

As a result, the optimum set of filter coefficients for the UE can be obtained by minimizing the following cost function, expressed as a ratio of the accumulated energy of the estimated composite channel impulse response outside of a target T_{w} time window to the accumulated energy within the target T_{w} time window, i.e.,

$$C ( w ) = \frac{{\sum }_{n = 0}^{D - {T}_{w} / 2 - 1} {\vert {\tilde{h}}_{comp} ( n ) \vert}^{2} + {\sum }_{n = D + {T}_{W} / 2 + 1}^{M - 1} {\vert {\tilde{h}}_{comp} ( n ) \vert}^{2}}{{\sum }_{n = D - {T}_{w} / 2}^{D + {T}_{W} / 2} {\vert {\tilde{h}}_{comp} ( n ) \vert}^{2}} \qquad ( 10 )$$

where w={\hat{b}ₘ, m=1, 2, . . . , L₁, ĉₘ, m=0, 1, . . . , L₂−1} is a joint set of pre-equalizer coefficients, D is a target delay of interest and it can be set to the peak sample index of \tilde{h}_{org}(n) plus half of L₂, T_{w} is a target time window to cover dominant samples and can be set less than the normal CP length, M is the length of the estimated composite channel impulse response.

In some implementations, scaling factors can be introduced to Equation (10) to emphasize certain samples so that the energy of each sample is scaled. For example, the energy of the n-th sample, i.e. |\tilde{h}_{comp}(n)|², becomes ρₙ|\tilde{h}_{comp}(n)|², where ρₙ is a pre-defined scaling factor for the n-th sample and it is ε(0,1].

In some implementations, instead of estimating directly the THP filter coefficients {\hat{b}ₘ}, one can express the transfer function of THP in a form of polynomial factorization, i.e.,

$$H ( z ) = 1 / [ {z}^{- {L}_{1}} {\prod }_{m = 1}^{{L}_{1}} ( z - {\hat{p}}_{m} ) ]$$

with a set of poles {\hat{p}ₘ, m=1, 2, . . . , L₁} and then estimate those poles in order to minimize the cost function in Equation (10).

In the derivation of Equation (3) and (7), the THP has been assumed to have a low-order and its impulse response to have a fast decay. In some implementations, to satisfy that assumption, the THP order L₁ can be set to a smaller value to guarantee a short order THP or even set to 0 to effectively bypass the THP. Conditions on the minimization such as limiting the amplitude of the filter coefficients of the THP so that its impulse response may have a faster decay can be further added to Equation (10).

Yet in some implementations, the cost function can be defined in the frequency domain to allow the filter coefficients to be adjusted such that the frequency response of the composite channel, i.e., \tilde{H}_{org}(k)·Ĥ_{FFE}(k)·Ĥ_{THP}(k), for all subcarriers is as flat as possible.

Adaptive algorithms can be used to adjust the filter coefficients towards the minimization of the cost function. For example, w(t) can be set to the coefficients previously determined and adjust the coefficients at steps proportional to the negative of the gradient of the cost function, i.e.

w(t+1)=w(t)−μ∇C(w) (11)

where μ/>0 is a small positive stepsize, ∇C(w) is the gradient of function C(w) defined in Equation (10) at w=w(t). The filter coefficients may be initialized to an all zero vector except ĉ₀, which can be set to 1 or initialized to the set of filter coefficients previously communicated to and being used by the UE. A condition on limiting the amplitude of the filter coefficients can be easily accommodated in the coefficient adaptation by setting the amplitude of the filter coefficients to a predefined boundary value if the amplitude after an update in Equation (11) exceeds the limit.

To determine a desired CP mode, the eNB may identify the multipath delay spread of the resulting composite channel 780. The eNB may use the estimated channel impulse response and pre-equalizer coefficient to estimate the multipath delay spread of the composite channel and compare it with one or more pre-defined multipath delay spread thresholds. More specifically, using the example described above, the eNB may use Equation (6) to compute the impulse response of a projected composite channel, ĥ_{comp}(n), if the set of pre-equalizer coefficients were used. The multipath delay spread of the projected composite channel can be estimated by calculating the delay power spectrum, φ_{c}(τ), which can be obtained by calculating the auto-correlation of the estimated composite channel impulse response and converting the calculated auto-correlation to the frequency domain, and finding a delay value, Tₘ, beyond which the normalized delay power is less than a pre-configured power threshold, i.e., φ_{c}(Tₘ)/φ_{c}(0)<\tilde{φ}_{T}, where \tilde{φ}_{T} is a pre-configured power threshold.

FIG. 8 is a block diagram showing an example implementation 800 of single-input-multiple-output (SIMO) uplink channel pre-equalization between a UE and an eNB. For SIMO, a single transmit antenna is used by the UE and N_{RxAnt}(N_{RxAnt}>1) receive antennas are used by the eNB. In the illustrated example implementation 800, the input signal fed to the system is denoted as X(k), the output signal corresponds to the first receive antenna at eNB is denoted as Y₁(k), and the output signal corresponds to the N_{RxAnt}-th receive antenna is denoted as Y_{N}_{_{RxAnt}}(k) Other output paths between 1 and N_{RxAnt} are not shown in FIG. 8. The IFFT blocks 810, CP insertion blocks 820, CP removal blocks 860, 865 and FFT blocks 870, 875 perform substantially similar functionalities as respectively, the IFFT block 410, CP insertion block 420, CP removal block 450 and FFT block 460 as described in the illustration of FIG. 4. The wireless channel becomes a SIMO channel that has N_{RxAnt} spatial paths (two spatial paths 850 and 855 are shown). The channel pre-equalization performed by the pre-equalizer in this example 800 is based on THP 830 and a FFE 840. The channel impulse response estimation and pre-equalizer coefficients determination at the eNB for the SIMO example in FIG. 8 is described in the following illustration.

For channel impulse response estimation, the channel impulse response estimation in SIMO case is similar to that in SISO case except that SIMO case has multiple channels for multiple receive antennas. By assuming the THP has a short length and its impulse response has a fast decay and the multipath delay spread of the composite channel is less than the CP duration of the CP being used, the received frequency domain sample for subcarrier k can be written as

Yᵣ(k)=H_{org,r}(k)·H_{FFE}(k)·H_{THP}(k)·X(k)+Nᵣ(k) r=1,2, . . . ,n (12)

where the subscript r denotes the receive antenna index, H_{THP}(k), and H_{FFE}(k) are the frequency responses at subcarrier k of the THP and FFE being used at the transmitter side (The UE side), respectively. In some instances, the THP and FFE are common for each receive channel.

By following the same approach as that in the SISO example described in the illustration of FIG. 7, the frequency response of the r-th original channel H_{org,r} (k) can be estimated, from which the channel impulse response estimate can be derived. In addition, the eNB may perform some forms of averaging on the channel impulse response estimates if applicable to reduce the estimation error.

For pre-equalizer coefficient determination, similarly to the SISO example described in the illustration of FIG. 7, the pre-equalizer coefficient determination in the SIMO example 800 is to identify a set of THP coefficients {\hat{b}ₘ, m=1, 2, . . . , L₁} and a set of FFE coefficients {ĉₘ, m=0, 1, . . . , L₂−1}, such that the projected impulse responses of all N_{RxAnt} composite channels may have a shorter multipath delay spread. It can be defined that,

\tilde{h}_{comp,r}(n)=IFFT{\tilde{H}_{org,r}(k)·Ĥ_{FFE}(k)·Ĥ_{THP}(k)} r=1,2, . . . ,N_{RxAnt} (13)

where \tilde{H}_{org,r}(k) is the frequency-domain estimate of the original channel for receive antenna r.

As a result, the optimum set of filter coefficients can be obtained by minimizing the following cost function, expressed as a ratio of the accumulated energy of the estimated composite channel impulse response outside of a target T_{w} time window and across all receive antennas to the accumulated energy within the target T_{w} time window and across all receive antennas, i.e.,

$$C ( w ) = \frac{{\sum }_{r} \{ {\sum }_{n = 0}^{D - {T}_{w} / 2 - 1} {\vert {\tilde{h}}_{comp , r} ( n ) \vert}^{2} + {\sum }_{n = D + {T}_{W} / 2 + 1}^{N - 1} {\vert {\tilde{h}}_{comp , r} ( n ) \vert}^{2} \}}{{\sum }_{r} \{ {\sum }_{n = D - {T}_{w} / 2}^{D + {T}_{W} / 2} {\vert {\tilde{h}}_{comp , r} ( n ) \vert}^{2} \}} \qquad ( 14 )$$

Here, D can be set to the average of peak sample indices of \tilde{h}_{org,r}(n) plus half of L₂. Finally, an adaptive algorithm can be used to search for the optimum solution.

The desired CP mode determination in SIMO case is similar to that in the SISO case (FIG. 7) except that the multipath delay spreads of all N_{RxAnt} composite channels may be identified. The eNB may first compute the impulse response of all estimated composite channels, {ĥ_{comp,r}(n), r=1, 2, . . . , N_{RxAnt}}, if the set of pre-equalizer coefficients were used.

$${\hat{h}}_{comp , r} ( n ) = {\tilde{h}}_{org , r} ( n ) * {\hat{h}}_{FFE} ( n ) - {\sum }_{m = 1}^{{L}_{1}} {\hat{b}}_{m} {\hat{h}}_{comp , r} ( n - m ) \\ r = 1 , 2 , … , {N}_{RxAnt} \qquad ( 15 )$$

where * denotes a linear convolution, \tilde{h}_{org,r}(n) is the impulse response estimate of the original channel corresponding to the r-th receive antenna, ĥ_{FFE}(n) is the impulse response of the FFE based on the calculated FFE coefficients {ĉₘ, m=0, 1, . . . , L₂−1}, and {\hat{b}ₘ, m=1, 2, . . . , L₁} are the set of calculated THP coefficients.

For the r-th estimated composite channel, its multipath delay spread can be estimated by calculating the delay power spectrum φ_{c}(τ), and finding a delay value, denoted by Tₘ, beyond which the normalized power is less than a pre-configured power threshold, i.e., φ_{c}(Tₘ)/φ_{c}(0)<\tilde{φ}_{T}. Then a maximum multipath delay spread Tₘ from T_{RxAnt} multipath delay spreads can be identified. The eNB may further compare the maximum Tₘ with one or more multipath delay spread thresholds, each of which is corresponding to a CP mode and can be set equal to the CP length of the corresponding CP mode. If Tₘ<the multipath delay spread threshold corresponding to the Normal CP, the desired CP mode can be set to “Normal”. Otherwise, the desired CP mode can be set to “Extended”.

FIG. 9 is a block diagram showing an example implementation 900 of multiple-input-multiple-output (MIMO) uplink channel pre-equalization between a UE and an eNB. In this example implementation 900, a single user MIMO case is considered. For MIMO, multiple antennas are used by both the UE and the eNB. In the illustrated example implementation 900, the UE has N_{TxAnt} transmit antennas, and the eNB has N_{RxAnt} receive antennas. The input signal corresponds to the first transmit antenna at the UE is denoted as X₁(k), the input signal corresponds to transmit antenna N_{TxAnt} at the UE is denoted as X_{N}_{_{TxAnt}}(k) The output signal corresponds to the first receive antenna at eNB is denoted as Y₁(k), and the output signal corresponds to the N_{RxAnt}-th receive antenna is denoted as Y_{N}_{_{RxAnt}}(k). The IFFT blocks 910, 915, CP insertion blocks 920, 925, CP removal block 955, 960 and FFT blocks 965, 970 perform substantially similar functionalities as respectively, the IFFT block 410, CP insertion block 420, CP removal block 450 and FFT block 460 as described in the illustration of FIG. 4. The wireless channel 950 is a MIMO channel that has N_{TxAnt}×N_{RxAnt} spatial channels. The channel pre-equalization performed by the pre-equalizer in this example 900 is based on THP 930, 935 and FFE 940, 945. The channel impulse response estimation and pre-equalizer coefficients determination at the eNB for the SIMO example in FIG. 9 is described in the following illustration. Note that structures of THP 930, 935 and FFE 940, 945 are considered separated for each transmit antenna.

For channel impulse response estimation, N_{TxAnt} non-overlapped or orthogonal set of DMRS are used. As such, the channel impulse response estimation for uplink signals from each transmit antenna in the MIMO case may be substantially similar to the channel impulse response estimation of the SIMO case as described in the illustration of FIG. 8. The process of estimating channel impulse response for one particular transmit antenna can be repeated to obtain channel impulse response estimates for all transmit antennas.

For pre-equalization coefficients determination, the pre-equalizer coefficients determination for each transmit antenna may be the same as the pre-equalizer coefficients determination for the SIMO case. Similar to channel impulse response estimation, the pre-equalization coefficients determination process for one particular antenna can be repeated for all transmit antennas.

The desired CP mode determination in single user MIMO case is similar to the desired CP mode determination in the SIMO case except that the multipath delay spreads of all N_{TxAnt}×N_{RxAnt} composite channels may be checked. The eNB may first estimate all composite channels, {ĥ_{comp,p,r}(n), p=1, 2, . . . , N_{TxAnt}, r=1, 2, . . . , N_{RxAnt}}, if the set of pre-equalizer coefficients were used, i.e.,

$${\hat{h}}_{comp , p , r} ( n ) = {\tilde{h}}_{org , p , r} ( n ) * {\hat{h}}_{FFE , p} ( n ) - {\sum }_{m = 1}^{{L}_{1}} {\hat{b}}_{m , p} {\hat{h}}_{comp , p , r} ( n - m ) , \\ p = 1 , 2 , … , {N}_{TxAnt} , r = 1 , 2 , … , {N}_{RxAnt} , \qquad ( 16 )$$

where * denotes linear convolution, \tilde{h}_{org,p,r}(n) is the impulse response estimate of the original channel corresponding the channel from transmit antenna p to receive antenna r, ĥ_{FFE,p}(n) is the impulse response of the FFE for transmit antenna p based on the calculated FFE coefficients {ĉ_{m,p}, m=0, 1, . . . , L₂−1}, while {\hat{b}_{m,p}, m=1, 2, . . . , L₁} are the set of calculated THP coefficients for transmit antenna p. For each antenna pair (i.e., an uplink spatial channel) between the UE and the eNB, the multipath delay spread can be estimated. Then, a maximum multipath delay spread Tₘ from the estimated multipath delay spread values for all antenna pairs can be found. The eNB can then compare the maximum Tₘ with one or more multipath delay spread thresholds corresponding to CP modes. If Tₘ<the multipath delay spread threshold corresponding to the Normal CP mode, the desired CP mode for the UE is set to “Normal”. Otherwise, the desired CP mode is set to “Extended”.

In some implementations, when N_{TxAnt}=N_{RxAnt}, it is possible to allow inter-connected THPs and FFEs across transmit antennas. It is to be understood that the single user MIMO channel impulse response and pre-equalization coefficient determination processes can be extended to the multi-user MIMO transmission using substantially similar methods as described above. The technology described in the present disclosure can be applied to both frequency division duplex and time division duplex wireless systems.

While this document contains many specifics, these should not be construed as limitations on the scope of a disclosure that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method comprising:
receiving, from each of a plurality of mobile devices, an uplink signal;
estimating, based on the received uplink signal, a channel characteristic of an uplink channel for each of the plurality of mobile devices; and
determining, based on comparing the estimated channel characteristic to a characteristic threshold, a cyclic prefix mode for each of the plurality of mobile devices.

2. The method of claim 1, wherein a same cyclic prefix mode is determined for a subset of the plurality of mobile devices, further comprising configuring the subset of mobile devices to transmit a plurality of uplink signals in a same time interval using the same determined cyclic prefix mode.

3. The method of claim 1, further comprising, prior to receiving the uplink signal, assigning a first cyclic prefix mode to each of the plurality of mobile devices.

4. The method of claim 1, wherein the uplink signal is at least one of an uplink data signal, an uplink sounding reference signal or an uplink demodulation reference signal.

5. The method of claim 1, wherein the channel characteristic of the uplink channel is a multipath delay spread of the uplink channel, and the characteristic threshold is a multipath delay spread threshold.

6. The method of claim 3, wherein the cyclic prefix mode comprises at least two cyclic prefix modes, the at least two cyclic prefix modes include the first cyclic prefix mode associated with a first cyclic prefix length, and a second cyclic prefix mode associated with a second cyclic prefix length.

7. The method of claim 6, wherein configuring at least a subset of mobile devices further includes:
generating, for each of the plurality of mobile devices, a corresponding indicator based on the determined cyclic prefix mode; and
assigning a first subset of the plurality of mobile devices having a first cyclic prefix mode a first time interval to transmit uplink signals, and a second subset of the plurality of mobile devices having an second cyclic prefix mode a second time interval to transmit uplink signals.

8. The method of claim 7, further comprising:
transmitting the corresponding indicator to each of the plurality of mobile devices; and
transmitting information identifying the assigned first time interval to the first subset of the plurality of mobile devices, and information identifying the assigned second time interval to the second subset of the plurality of mobile devices.

9. The method of claim 8, wherein the generated indicator is embedded in at least one of the transmitted information, or a radio resource control message.

10. The method of claim 8, wherein transmitting the corresponding indicator further includes transmitting by broadcasting, at a downlink time interval, an indicator identifying either the first cyclic prefix mode or the second cyclic prefix mode for an uplink time interval that is later than the downlink time interval by a predetermined time.

11. The method of claim 1, further comprising:
determining, based on at least one of the received uplink signal, one or more equalizer coefficients for channel pre-equalization at each of a subset of the plurality of mobile devices; and
transmitting information identifying the one or more equalizer coefficients to each of the subset of the plurality of mobile devices.

12. The method of claim 11, further comprising:
estimating, based on the determined one or more equalizer coefficients and the received uplink signal, a second channel characteristic for each of the subset of the plurality of mobile devices after channel pre-equalization; and
determining, based on comparing the estimated second channel characteristic to the characteristic threshold, a cyclic prefix mode for each of the subset of the plurality of mobile devices.

13. A method comprising:
transmitting, to a base station, a first signal using a first cyclic prefix mode associated with a first cyclic prefix length;
receiving, from the base station, an indicator indicating an updated cyclic prefix mode, wherein the updated cyclic prefix mode is either the first cyclic prefix mode associated with a first cyclic prefix length or the second cyclic prefix mode associated with a second cyclic prefix length;
receiving, from the base station, scheduling information identifying a radio resource for an uplink signal transmission; and
transmitting, to the base station, a second signal using the updated cyclic prefix mode and the radio resource identified in the received scheduling information.

14. The method of claim 13, wherein the first signal is a first pre-equalized signal generated by a filter using one or more pre-determined equalizer coefficients, further comprising receiving, from the base station, information associated with one or more updated equalizer coefficients after transmitting the first pre-equalized signal.

15. The method of claim 14, wherein the second signal is a second pre-equalized signal generated by the filter using the one or more updated equalizer coefficients.

16. The method of claim 15, wherein the first pre-equalized signal is generated by the filter after inserting a first cyclic prefix with the first cyclic prefix length.

17. The method of claim 13, wherein the filter using one or more pre-determined equalizer coefficients is a whole-pass filter.

18. A base station comprising:
at least one hardware processor operable to execute instructions to:
receive, from each of a plurality of mobile devices, an uplink signal;
estimate, based on the received uplink signal, a channel characteristic of an uplink channel for each of the plurality of mobile devices; and
determine, based on comparing the estimated channel characteristic to a characteristic threshold, a cyclic prefix mode for each of the plurality of mobile devices.

19. The base station of claim 18, wherein a same cyclic prefix mode is determined for a subset of the plurality of mobile devices, further comprising configuring the subset of mobile devices to transmit a plurality of uplink signals in a same time interval using the same determined cyclic prefix mode.

20. The base station of claim 18, the at least one hardware processor further operable to execute instructions to, prior to receive the uplink signal, assign a first cyclic prefix mode to each of the plurality of mobile devices.

21. The base station of claim 18, wherein the uplink signal is at least one of an uplink data signal, an uplink sounding reference signal or an uplink demodulation reference signal.

22. The base station of claim 18, wherein the channel characteristic of the uplink channel is a multipath delay spread of the uplink channel, and the characteristic threshold is a multipath delay spread threshold.

23. The base station of claim 20, wherein the cyclic prefix mode comprises at least two cyclic prefix modes, the at least two cyclic prefix modes include the first cyclic prefix mode associated with a first cyclic prefix length, and a second cyclic prefix mode associated with a second cyclic prefix length.

24. The base station of claim 23, wherein configure at least a subset of mobile devices further includes:
generate, for each of the plurality of mobile devices, a corresponding indicator based on the determined cyclic prefix mode; and
assign a first subset of the plurality of mobile devices having a first cyclic prefix mode a first time interval to transmit uplink signals, and a second subset of the plurality of mobile devices having an second cyclic prefix mode a second time interval to transmit uplink signals.

25. The base station of claim 24, the at least one hardware processor further operable to execute instructions to:
transmit the corresponding indicator to each of the plurality of mobile devices; and
transmit information identifying the assigned first time interval to the first subset of the plurality of mobile devices, and information identifying the assigned second time interval to the second subset of the plurality of mobile devices.

26. The base station of claim 25, wherein the generated indicator is embedded in at least one of the transmitted information, or a radio resource control message.

27. The base station of claim 25, wherein transmitting the corresponding indicator further includes transmitting by broadcasting, at a downlink time interval, an indicator identifying either the first cyclic prefix mode or the second cyclic prefix mode for an uplink time interval that is later than the downlink time interval by a predetermined time.

28. The base station of claim 18, the at least one hardware processor further operable to execute instructions to:
determine, based on at least one of the received uplink signal, one or more equalizer coefficients for channel pre-equalization at each of a subset of the plurality of mobile devices; and
transmit information identifying the one or more equalizer coefficients to each of the subset of the plurality of mobile devices.

29. The base station of claim 28, the at least one hardware processor further operable to execute instructions to:
estimate, based on the determined one or more equalizer coefficients and the received uplink signal, a second channel characteristic for the subset of the plurality of mobile devices after channel pre-equalization; and
determine, based on comparing the second estimated channel characteristic to the characteristic threshold, a cyclic prefix mode for each of the subset of the plurality of mobile devices.

30. A mobile device comprising:
at least one hardware processor operable to execute instructions to:
transmit, to a base station, a first signal using a first cyclic prefix mode associated with a first cyclic prefix length;
receive, from the base station, an indicator indicating an updated cyclic prefix mode, wherein the updated cyclic prefix mode is either the first cyclic prefix mode associated with a first cyclic prefix length or a second cyclic prefix mode associated with a second cyclic prefix length;
receive, from the base station, scheduling information identifying a radio resource for an uplink signal transmission; and
transmit, to the base station, a second signal using the updated cyclic prefix mode and the radio resource identified in the received scheduling information.

31. The mobile device of claim 30, wherein the first signal is a first pre-equalized signal generated by a filter using one or more pre-determined equalizer coefficients, further comprising receiving, from the base station, information associated with one or more updated equalizer coefficients after transmitting the first pre-equalized signal.

32. The mobile device of claim 31, wherein the second signal is a second pre-equalized signal generated by the filter using the one or more updated equalizer coefficients.

33. The mobile device of claim 31, wherein the first pre-equalized signal is generated by the filter after inserting a first cyclic prefix with the first cyclic prefix length.

34. The mobile device of claim 30, wherein the filter using one or more pre-determined equalizer coefficients is a whole-pass filter.
